(19) United States
(12) Patent Application Publication
(10) Pub. No.: US 2006/0082440 A1
(43) Pub. Date: Apr. 20, 2006

(54) Shelf arrangement and shelf unit

(75) Inventors: Rupert Glaser, Munich (DE); Christl Lauterbach, Hohenkirchen-Siegertsbrunn (DE); Thomas Sturm, Kirchheim (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/251,623

(22) Filed: Oct. 14, 2005

(30) Foreign Application Priority Data
Oct. 14, 2004 (DE) 10 2004 050 089.4

(51) Int. Cl. G05B 19/00; G05B 23/00; G06F 7/00; G06F 7/04; G08B 29/00; G06F 7/08; G06Q 20/00; G08C 19/00; H04B 1/00; H04B 3/00; H04Q 1/00; H04Q 9/00

(52) U.S. Cl. 340/5.91; 705/20

(57) ABSTRACT

A shelf arrangement has a multiplicity of shelf units, each shelf unit having a receiver and a processor coupled thereto. Each receiver is set up to receive data from a data transmission unit fitted on an object which is to be arranged or is arranged in the respective shelf unit. Each processor is set up such that it can determine the position of the shelf unit's processor within the shelf arrangement by virtue of messages being interchanged by processors in directly adjacent shelf units.

### CROSS-REFERENCE TO RELATED APPLICATION

This application claims priority to German Patent Application Serial No. 10 2004 050 089.4-53, which was filed on Oct. 14, 2004.

### FIELD OF THE INVENTION

The invention relates to a shelf arrangement and to a shelf unit.

### BACKGROUND OF THE INVENTION

In warehousing, stored goods units need to be electronically recorded and catalogued and the storage location of the respective goods unit within a warehouse needs to be managed electronically in order to be able to be found again and used at a later time. In this case, the goods units which are to be stored need to be recorded both when the goods unit enters the warehouse and when the goods unit leaves the warehouse.

This has been done in line with the prior art by manually recording goods units which enter and leave the warehouse and by recording the storage location of the goods units within the warehouse.

However, this gives rise to some drawbacks, such as high susceptibility to error on account of the data being input manually, high costs on account of the employment of personnel for manually recording the data, strict provisions for selecting the storage location and the associated high level of involvement for internally restructuring the warehouse, and an inventory which is intensive in terms of cost and personnel.

In modern warehousing, the stored goods units are provided with identification labels, which can comprise a simple bar code or what are known as RFID tags.

RFID (Radio Frequency IDentification) tags are particular identification labels which can be identified by radio. The RFID tags store the desired data or the data which is required on the basis of the application.

The use of RFID tags allows a relatively large volume of data stored in the memory in the respective RFID tag to be read from the memory without contact. This provides a simple and failsafe way of transferring goods descriptions contained in the data to an electronic bookkeeping system.

To date, however, this has applied only to goods inward and goods outward for the goods units. Finding stored goods units again in the face of constantly changing demands on the structure of the warehouse is a significant problem even for the goods units which are provided with RFID tags. If the storage location within the warehouse changes and this information is not simultaneously followed up in the electronic bookkeeping system then searching for the goods unit is time-consuming and hence costly. Restructuring the entire content of the warehouse requires a high level of organization and necessitates that the storage locations for all goods units which have moved, i.e. have had their storage location changed, be rerecorded, which is associated with increased employment of personnel. For this reason, restructuring and hence movement of the goods units within the warehouse are normally not done as often as would be necessary and appropriate for the flow of operations.

In addition, DE 101 13 072 A1 describes a system for storing and dispensing objects which is based on a cabinet which has stipulated slots.

In addition, DE 101 11 956 C1 describes a storage room containing stored items which each have an associated transponder. Each transponder has an information content. In addition, the storage room contains a multiplicity of antennas which are arranged in the form of an antenna matrix in the storage room. To find the position of the individual stored items, the antennas in the antenna matrix are actuated individually.

T. Schröder, Für Fabriken, Kaufhäuser, ja sogar Briefmarken: die Zukunft der Transponder [For Factories, Department stores, or even stamps: the future of transponders], Siemens AG, June 2004, describes the application of RFID transponders for labels for identifying items of clothing.

### SUMMARY OF THE INVENTION

A shelf arrangement having a plurality of shelf units. Each shelf unit has a shelf base and at least one shelf vertical connection device, where the shelf base and the shelf vertical connection device can be releasably coupled to one another, a receiver which is arranged in the shelf unit and is set up to receive data from a data transmission unit fitted on an object which is to be arranged or is arranged in the shelf unit, and a processor which is set up such that it can determine a position of a processor element of a shelf unit within the shelf arrangement by interchanging messages with processor elements in directly adjacent shelf units. The processor elements and the receivers in the plurality of shelf units are able to be coupled to one another and to a central processing unit for a purpose of transmitting the data obtained using the receiver to the central processing unit.

### BRIEF DESCRIPTION OF THE DRAWINGS

Exemplary embodiments of the invention are illustrated in the drawings and are explained in more detail below. In the figures, identical components have been provided with identical reference symbols.

FIG. 1 shows a schematic front view of a shelf arrangement, in line with an exemplary embodiment of this invention, which is made up of shelf bases and shelf vertical connection devices;

FIG. 2 shows a schematic detailed view of a shelf vertical connection device and of the shelf base in line with the exemplary embodiment of this invention;

FIG. 3 shows a schematic detailed view of the shelf vertical connection device in line with the exemplary embodiment of this invention;

FIG. 4 shows a cross section through the shelf base in line with the exemplary embodiment of this invention;

FIG. 5 shows a cross section through the shelf vertical connection device in line with the exemplary embodiment of this invention; and

FIG. 6 shows a schematic view of a developed coordinate system for a shelf unit in line with the exemplary embodiment of the invention.

### DETAILED DESCRIPTION OF PREFERRED EMBODIMENTS OF THE INVENTION

The invention is based on an object of specifying a shelf arrangement and a shelf unit which allow simpler and less expensive management of objects, particularly goods units, located in the shelf arrangement or in the shelf unit.

A shelf arrangement has a multiplicity of shelf units, each shelf unit having a shelf base and at least one shelf vertical connection device which are both able to be or both are releasably coupled to one another.

In addition, each shelf unit contains a receiver, arranged in it, for receiving data from a data transmission unit fitted on an object which is to be arranged or is arranged in the shelf unit. In addition, the shelf unit has a processor which is arranged in the shelf unit and which is respectively set up such that it can determine the position of the respective shelf unit's processor within the shelf arrangement by interchanging messages with processors in directly adjacent shelf units. The processors and the receivers in the multiplicity of shelf units can be coupled or are coupled to one another and can be coupled or are coupled to a central processing unit for the purpose of transmitting the data obtained using the receiver to the central processing unit.

The advantages of this shelf arrangement are that the content of a store and the storage location of each individual goods unit, generally of each individual object, is automatically recorded correctly in the data management system at any time, that movement of an object from one storage location to another storage location is automatically communicated to a preferably central data management system without any human involvement, that inventories can be produced at the “touch of a button” and correctly and that restructuring of the store can be planned and performed without any problem. This applies both to global restructuring (central planning using the data management system) and to local measures, for example when extending the stored quantity of a particular stored unit by using storage locations which were originally provided for something else.

One aspect of the invention can clearly be seen as being that the shelf arrangement is a self-organizing shelf arrangement with a multiplicity of shelf units, each shelf unit respectively being formed from a shelf base and at least one shelf vertical connection device. The shelf base is used to represent the position of an object which is stored or arranged in the respective shelf unit. A shelf base may contain an object, particularly a goods unit, which is to be stored.

An object may have any number of partial objects, for example a goods unit may contain a plurality of partial goods units. By way of example, a pallet comprising a plurality of single units (the partial goods units) combined into one goods unit can form a goods unit.

The stored objects are provided with an identification object, for example with an RFID tag, which can be read electronically, preferably using a radio signal, and the shelf base is equipped with a corresponding reader which is set up such that it can read the digital information stored in the RFID tag of an object, i.e. particularly of a goods unit, contained in the respective shelf unit.

The goods units to be stored can thus be provided with RFID tags, and the shelf units record the stored goods units using the corresponding RFID readers, by reading the data stored in the memory in a respective RFID tag. To ensure that the respective RFID tag reader in a shelf unit reads only the data from the memories in those RFID tags which are situated in the respective shelf unit, the storage unit is preferably provided with a shield to shield electromagnetic radiation from the shelf units arranged next to one another.

The individual shelf units record the stored units, autonomously determine their own position within a structure comprising a multiplicity of interconnected shelf units, and possibly communicate with a central management unit.

In addition, the shelf units are provided with processor elements which form a regular, but possibly incomplete, network within the shelf system and which organize themselves using specific algorithms, i.e. determine their position by interchanging messages with directly adjacent processors in directly adjacent shelf units and independently set up suitable communication paths (routing paths) to the central management unit. The data from every stored unit in the self-organizing shelf arrangement are automatically sent to the central management unit so as to be processed further and stored there by an electronic store management system.

Preferably, at least some of the receivers are arranged in a respective shelf base. This achieves very simple unambiguous position finding for an object within the shelf arrangement regardless of the number and arrangement of shelf vertical connection devices, since in this case use is made of the fact that a shelf unit is respectively unambiguously identified by means of the shelf base on which the respective object has been placed.

In one preferred exemplary embodiment, the receiver is provided as a reading device for the radio-based reading of information from the element which is fitted on the object and which has the data transmission unit, particularly as an RFID reading device.

This particularly allows the reading of a goods unit which is stored in the respective shelf unit and which is provided with a special identification code element, for example an RFID tag.

The receiver is preferably designed to have an antenna. In other words, this means that, by way of example, the RFID tag has an antenna for picking up and emitting electromagnetic energy.

The antenna can be used for wirelessly receiving information, i.e. data, about the goods unit stored in a respective shelf unit.

In one development of the invention, at least one of the shelf units, preferably a plurality of or all shelf units, has/have a respective display unit, for example a light emitting diode, a small TFT screen etc.

The use of a display unit allows a respective shelf unit to be used directly to show and to ascertain what goods unit is being stored in this or possibly in other shelf unit(s) too. In addition, it is also possible for a user to be shown further detailed information about the object which is located in the respective shelf unit or in another shelf unit, for example goods characteristics such as name, place of origin, date of manufacture, goods description etc., and for said user to ascertain said information in a very simple manner.

Preferably, the shelf arrangement has a power supply interface for supplying power to the shelf arrangement, with the processors and/or the receiver being able to be coupled to the power supply interface.

Preferably, the shelf units have electrical lines to a respective local interface, with the local interfaces being able to be coupled to a central interface and the central interface being able to be coupled to a central processing unit.

In line with another refinement of the invention, the shelf arrangement has plug connector portions for mechanically coupling the shelf base to the shelf vertical connection device, with at least a first plug connector portion (for example a male connector) and/or at least a second plug connector portion (for example a female connector) being arranged in the shelf base, and at least a first plug connector portion (for example a male connector) and/or a second plug connector portion (for example a female connector) being arranged in the shelf vertical connection device. This makes it a very simple matter for the shelf base and the shelf vertical connection device, for example shelf struts or one or more shelf sidewalls, to be plugged into one another and taken apart again, which allows very simple assembly of the individual shelf units and the shelf arrangement.

Preferably, at least one of the shelf units has a shield for electromagnetically shielding the electrical lines in the shelf base and/or in the shelf vertical connection device.

This achieves failsafe reading, in general terms communication between the reading device and the identification code element fitted on the respective object, for example the RFID tag.

In one specific development, the shield is a metal foil.

A metal foil is a very inexpensive and simple means for achieving very good electromagnetic shielding for the lines.

At least one of the shelf units can have a backplane in which preferably electrical lines can be made, in other words integrated.

In a further refinement of the invention, a shelf unit contains a plurality of shelf vertical connection devices which are preferably in the form of metal, plastic or wooden struts.

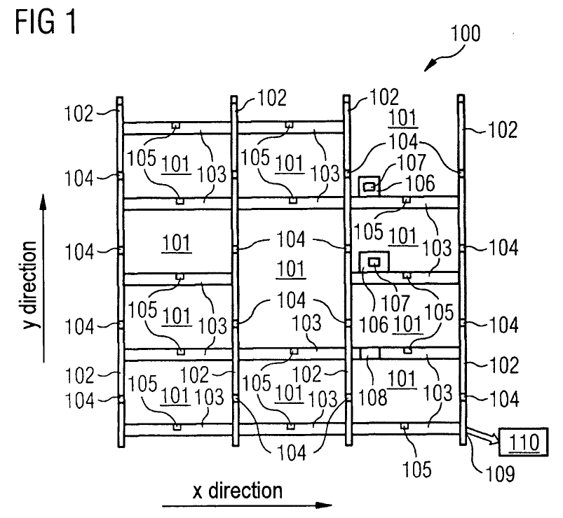

FIG. 1 is a schematic front view of a shelf arrangement 100, in line with an exemplary embodiment of the invention, which is made up of shelf bases and shelf vertical connection devices.

The shelf arrangement 100 is formed by a multiplicity of shelf units 101, with each of the shelf units 101 being formed from a plurality of shelf vertical connection devices 102, in line with this exemplary embodiment in the form of shelf walls 102, and a shelf base 103. The shelf walls 102 are arranged vertically, in the y direction, and the shelf bases 103 are designed to be horizontal, in the x direction, as required, between or on the shelf walls 102, and are preferably plugged into the latter.

The shelf walls 102 and shelf bases 103 can be put together, as part of a provided basic grid which specifies the dimensions of the shelf unit, and hence of the shelf wall, such as the width, depth and height of the shelf wall, in any number and any arrangement, as in an inherently ordinary shelf system.

Each of the shelf walls 102 contains, at intervals corresponding to a prescribed basic grid which is provided, processor elements 104 which are preferably “ADNOS” processor elements (ADNOS=Algorithmic Device Network Organization System) and which are set up such that they can ascertain their respective local position within the shelf arrangement through their own organization by means of local message interchange, in each case exclusively with directly adjacently arranged processor elements 104.

The processor elements 104 are set up as illustrated in DE 101 58 781 A1, DE 102 57 672 A1, and Thomas F. Sturm, Stefan Jung, Guido Stromberg, and Annelie Stöhr, “A Novel Fault-Tolerant Architecture for Self-Organizing Display and Sensor Arrays”, SID Symposium Digest of Technical Papers, Vol. 33, No. 2, pp. 1316-1319, 2002; for example.

The processor elements 104 are coupled to one another and to a central management computer (explained in more detail below) within the shelf base 103 vertically by means of conductor tracks. The conductor tracks are in a form such that the processor elements 104 can communicate with one another using these conductor tracks, i.e. can interchange digital data and can determine their position within the shelf arrangement.

By using the shelf bases 103, which likewise have conductor tracks, electrically conductive couplings are formed horizontally between shelf bases and/or shelf walls, which are arranged adjacent to one another, and/or with the central management computer.

Each shelf base 103 has a receiver 105 which is in the form of an RFID (Radio Frequency IDentification) reader. The receiver 105 detects the goods units 106 placed on the respective shelf base 103, to be more precise the RFID tags 107 fitted to the goods units, and reads the data stored in the memory in the respective RFID tag 107, for example the latter's identification code or more detailed information about the goods unit 106.

Each RFID reader 105 is coupled to a respective processor element 104 by means of the conductor tracks integrated in the shelf base 103 and in the shelf side walls, to be more precise in the shelf side walls or alternatively or in addition in the shelf backplanes.

Optionally, the shelf bases 103 can be designed to have display units 108 which are actuated by the processor elements 104.

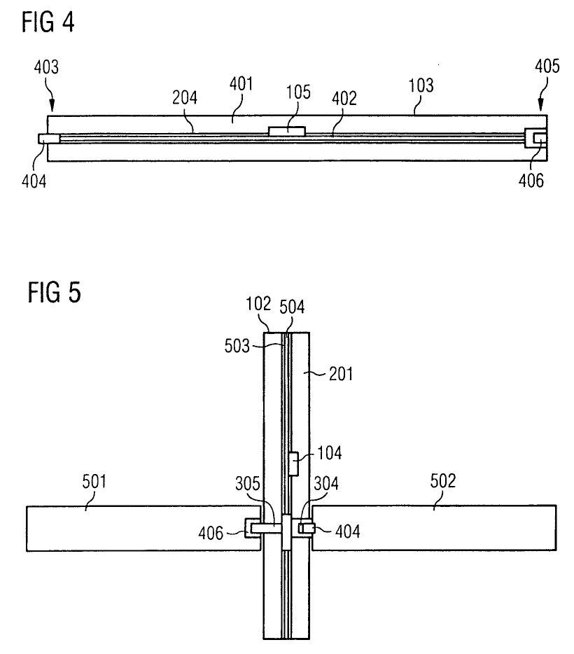

The shelf base 103 and the shelf walls 102 can respectively be mechanically coupled to one another by means of contacts, which are described in more detail in FIG. 3 and FIG. 4.

In addition, provision is made for the shelf arrangement 100 to be electrically coupled to a portal computer 110, in other words a central management computer 110, by means of an interface 109.

The coupling to the central management computer 110, which is typically a workstation or a network of computers, allows data processing and data management using a data link to logistical software, such as SAP/R3.

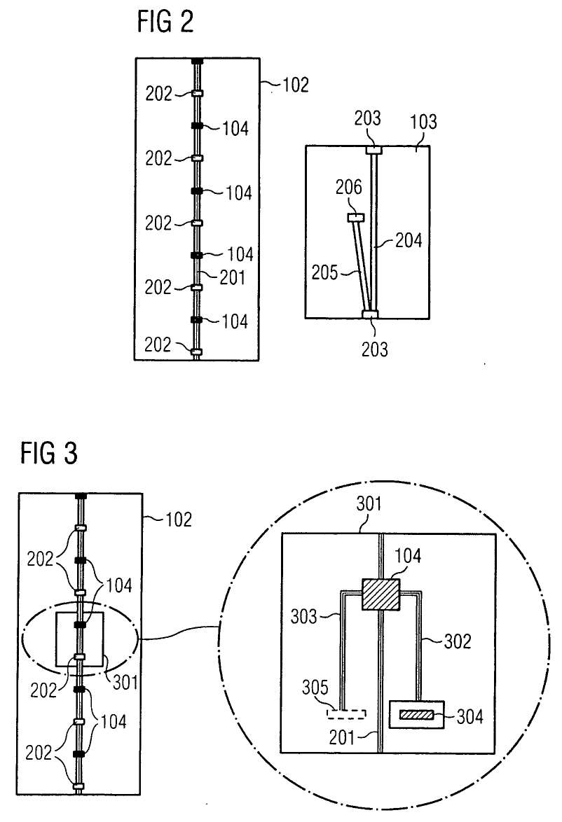

FIG. 2 shows a schematic detailed view of the shelf wall 102 and of the shelf base 103 in line with the exemplary embodiment of the invention.

Each shelf wall 102 contains processor elements 104 at a prescribed position based on the basic grid provided, said processor elements preferably being designed in accordance with the processor elements described in DE 101 58 781 A1, DE 102 57 672 A1, or Sturm et al., with the descriptions from DE 101 58 781 A1, DE 102 57 672 A1, and Sturm et al. hereby being incorporated into the description in their entirety by way of reference, and said processor elements being coupled by means of electrical conductor tracks 201, or alternatively cables formed therein, which are produced in the y direction (when the shelf wall 102 is set up in the vertical direction).

The conductor tracks 201 allow the processor elements 104, which (in line with the method described in DE 101 58 781 A1 or DE 102 57 672 A1) can determine their local position within the shelf arrangement 100 through their own organization, to interchange information with one another, namely in each case with directly adjacently arranged processor elements 104, and in this way to determine their position.

In addition, the shelf wall 102 has a number of contacts 202—in line with this exemplary embodiment of the invention first plug connector portions (male connectors)—which corresponds to the basic grid provided, said contacts being able to be used for mechanically coupling and electrically coupling the shelf wall 102 and the shelf base 103.

The shelf base 103 likewise has contacts 203—in line with this exemplary embodiment of the invention second plug connector portions (female connectors)—which correspond, for the purpose of releasable mechanical coupling, to the first plug connector portions 202 on the shelf wall 102. In addition, the shelf base 103 has an electrical conductor track 204 in the x direction (when the shelf wall 102, which is set up in the y direction, is coupled to the shelf base 103, which is then oriented in the x direction). The conductor track 204 in the x direction is a connecting line to the processor elements 104.

In this exemplary embodiment, the shelf bases 103 thus connect the processor elements 104, which are arranged therein and which are respectively situated directly above, to one another horizontally. In addition, the shelf base 103 has an RFID reader 105, for the purpose of contactlessly reading the information which is stored in the memory in the RFID tag 107 fitted to the goods units 106.

The RFID reader 105 is coupled to an additional electrical conductor track 205 which is connected to the second plug connector portion 203, so that the information ascertained by the RFID reader 105 is routed to the conductor track 204 oriented in the x direction, which for its part then forwards this information to the processor elements 104 and finally along the routing path ascertained in line with DE 101 58 781 A1, DE 102 57 672 A1, or Sturm et al. to the central management computer 110.

A receiver antenna 206 provided in the RFID reader 105 transmits electromagnetic waves within a particular frequency range (radio waves in the case of RFID tags), said electromagnetic waves being received by a “transponder”, namely the RFID tag 107 which is fitted, for exampled bonded, to the stored goods. The RFID tag 107 uses the received electromagnetic waves firstly as an activation signal and secondly as an energy source.

On the basis of the received electromagnetic waves, the addressed RFID tag 107 reads the information which is stored in its memory and has been requested, codes the data which are read and transmits these data to the RFID reader 105. By way of example, the coded identification number of the stored goods unit, which goods unit has the RFID tag 107 fitted on it, and which identification number is stored in the memory in the RFID tag 107 are transmitted in this way to the RFID reader 105 using appropriately modulated electromagnetic waves (radio waves). The antenna 206 of the RFID reader 105 receives the electromagnetic waves. The RFID reader 105 decodes the data coded in the received electromagnetic waves, as a result of which the identification number of the stored goods unit is available in the RFID reader 105, for example, and can be forwarded from it to the central management computer 110.

FIG. 3 shows a schematic detailed view of the shelf wall 102 in line with the exemplary embodiment of the invention. The left-hand illustration in FIG. 3 is identical to the shelf wall 102 shown in FIG. 2.

The right-hand illustration in FIG. 3 shows an enlargement of a detail 301 from the shelf wall 102. In the detail 301 from the shelf wall 102, the shelf wall 102 has the conductor track 201, which is produced in the y direction (when the shelf wall 102 is set up in the vertical direction) as a connecting line between the processor elements 104 and which can be used by the processor elements 104 to interchange information with one another and to determine their position within the shelf wall 102.

In addition, in the detail 301 from the shelf wall 102, the shelf wall 102 has a second conductor track 302 and also a third conductor track 303, where the second conductor track 302 is connected to a first shelf wall plug connector portion 304, which is situated on a first lateral face of the shelf wall 102, and couples said shelf wall plug connector portion to the processor element 104, and where the third conductor track 303 has a second shelf wall plug connector portion 305, which is situated on a second lateral face of the shelf wall 102, and couples said shelf wall plug connector portion to the processor element 104, with the first lateral face of the shelf wall 102 and the second lateral face of the shelf wall 102 being opposite one another.

The first shelf wall plug connector portion 304 and the second shelf wall plug connector portion 305 together form the contacts 202 on the shelf wall 102, which are shown in FIG. 2 only as a small detail, and are in a form such that they are used for releasably mechanically and, if appropriate, additionally electrically coupling the shelf wall 102 to the shelf base 103.

A precise illustration of this mechanical coupling is given further below with reference to FIG. 4.

FIG. 4 shows a cross section through the shelf base 103 in line with the exemplary embodiment of the invention.

The figure shows the conductor track 204, oriented in the x direction, in the direction of the processor elements 104. The shelf base 103 also has a substrate 401 in which the conductor track 204 is made and also a shield 402, which is likewise made in the substrate, for electromagnetically shielding the conductor track 204. In line with this exemplary embodiment, the shield 402 is made from a metal foil 402, the metal used preferably being aluminum. The metal foil 402 is alternatively in the form of a layer within the shelf base 103.

Arranged in the central region of the shelf base 103 is the RFID reader 105. Arranged at one longitudinal end 403 of the shelf base 103 is a first shelf base plug connector portion 404, and arranged at the other longitudinal end 405 of the shelf base 103 is a second shelf base plug connector portion 406. The second shelf base plug connector portion 406 and the first shelf base plug connector portion 404 together form the contacts 203 on the shelf base 103, which are shown only as a small detail in FIG. 2, and are in a form such that they are used for mechanically and, if appropriate, electrically coupling the shelf base 103 to the shelf wall 102.

In this way, the shelf wall 102 and the shelf base 103 are releasably mechanically coupled to one another such that the first shelf base plug connector portion 404 is plugged into the first shelf wall plug connector portion 304 of a first shelf wall 102 at one longitudinal end 403 of the shelf base 103, and the second shelf base plug connector portion 406 is plugged into the second shelf wall plug connector portion 304 of a second shelf wall 102 at the other longitudinal end 405 of the shelf base 103.

FIG. 5 shows a cross section through a shelf wall 102 whose left-hand lateral face has a first shelf base 501 arranged on it and whose right-hand lateral face has a second shelf base 502 arranged on it.

The first shelf base 501 is fixed on the shelf wall 102 by means of the second shelf wall plug connector portion 305 on one lateral face of the shelf wall 102, said second shelf wall plug connector portion being plugged into the second shelf base plug connector portion 406 of the first shelf base 501, and the second shelf base 502 is fixed on the shelf wall 102 by means of the first shelf base plug connector portion 404 of the second shelf base 502, said first shelf base plug connector portion being plugged into the first shelf wall plug connector portion 304 on the other lateral face of the shelf wall 102.

Arranged in the central region of the shelf wall 102 is the processor element 104, and the shelf wall 102 also has a substrate 503 which holds the processor element 104 and in which the conductor tracks 204 and an additional shield 504 made of a metal foil are also integrated. The metal foil is preferably in the form of a layer within the shelf wall 102. In this exemplary embodiment, the metal used for the metal foil is preferably aluminum.

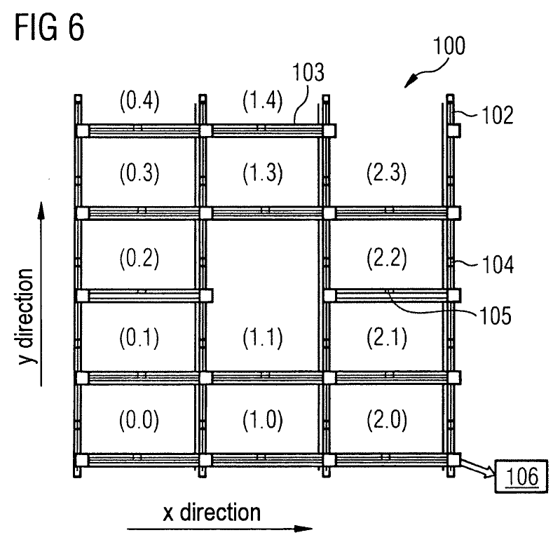

FIG. 6 shows a schematic view of a coordinate system in the shelf arrangement 100, which is formed from the shelf units 101, with shelf-wall-local position coordinates for the individual shelf units 101 formed within the shelf arrangement 100.

In the shelf arrangement 100, the shelf walls 102 and the shelf bases 103 of the shelf units 101 are combined to form a coordinate-like system.

The positions of the individual shelf units 101 are indicated in this coordinate system from the bottom left (position (0,0)) to the top right (position (2,3)), i.e. each shelf unit 101 corresponds to a coordinate point (x, y) within the coordinate system on the basis of an x value and a y value. The y value in the illustration shown in FIG. 6 is counted upward and the x value in the illustration in FIG. 6 is counted to the right.

FIG. 6 also shows that the shelf units 101 (x, y) do not all have to be of the same size. A first shelf unit 101 (1, 1), for example, is proportioned such that its size is twice that of a second shelf unit 101 (2, 1) or a third shelf unit 101 (2, 2).

FIG. 6 reveals that the shelf arrangement 100 can be made up of any number of shelf walls 102. There are therefore no restrictions with regard to the number of shelf walls 102 and shelf bases 103 used, which means that any number of shelf units 101 of different size is possible.

In one development, the receivers 105 or the processor elements 104 with the respective electrical lines may also be installed in the backplanes of the shelf walls (not shown here).

1-14. (canceled)

15. A shelf arrangement having a plurality of shelf units, each shelf unit comprising:
a shelf base and at least one shelf vertical connection device, where the shelf base and the shelf vertical connection device can be releasably coupled to one another;
a receiver which is arranged in the shelf unit and is set up to receive data from a data transmission unit fitted on an object which is to be arranged or is arranged in the shelf unit; and
a processor which is set up such that it can determine a position of a processor element of a shelf unit within the shelf arrangement by interchanging messages with processor elements in directly adjacent shelf units,
wherein the processor elements and the receivers in the plurality of shelf units are able to be coupled to one another and to a central processing unit for a purpose of transmitting the data obtained using the receiver to the central processing unit.

16. The shelf arrangement as claimed in claim 15, wherein at least some of the receivers are arranged in respective shelf bases.

17. The shelf arrangement as claimed in claim 15, wherein the receiver is a reading device.

18. The shelf arrangement as claimed in claim 17, wherein the reading device is an RFID reading device.

19. The shelf arrangement as claimed in claim 15, wherein the receiver has an antenna.

20. The shelf arrangement as claimed in claim 15, wherein at least one of the shelf units has a display unit.

21. The shelf arrangement as claimed in claim 15, further comprising a power supply interface for supplying power to the shelf arrangement, with the processor elements and/or the receiver being coupled to the power supply interface.

22. The shelf arrangement as claimed in claim 15, wherein the shelf units have electrical lines to respective local interfaces, with the local interfaces being coupled to a central interface and the central interface being coupled to a central processing unit.

23. The shelf arrangement as claimed in claim 15, further comprising plug connections for mechanically coupling the shelf base to the shelf vertical connection device, with at least a first plug connector portion and a second plug connector portion being arranged in the shelf base, and at least a first plug connector portion and a second plug connector portion being arranged in the shelf vertical connection device.

24. The shelf arrangement as claimed in claim 15, wherein at least one of the shelf units has a shield for electromagnetically shielding the electrical lines.

25. The shelf arrangement as claimed in claim 24, wherein the shield is a metal foil.

26. The shelf arrangement as claimed in claim 15, wherein at least one of the shelf units has a backplane with electrical lines formed therein.

27. The shelf arrangement as claimed in claim 15, wherein at least one of the shelf units has a plurality of shelf vertical connection units.

28. A shelf unit comprising:
a shelf base;
at least one shelf vertical connection device, where the shelf base and the shelf vertical connection device can be releasably coupled to one another;
a receiver which is set up to receive data from a data transmission unit fitted on an object which is to be arranged or is arranged in the shelf unit; and
a processor which is set up such that it can determine a position of a processor element of a shelf unit within the shelf arrangement by interchanging messages with processor elements in directly adjacent shelf units,
wherein the processor elements and the receivers are coupled to one another and to a central processing unit for a purpose of transmitting the data obtained using the receiver to the central processing unit.

29. A shelf arrangement having a plurality of shelf units, each shelf unit comprising:
a shelf base and at least one shelf vertical connection device, where the shelf base and the shelf vertical connection device can be releasably coupled to one another;
a receiving means which is arranged in the shelf unit and is set up to receive data from a data transmission means fitted on an object which is to be arranged or is arranged in the shelf unit; and
a processing means which is set up such that it can determine a position of a processor element means of a shelf unit within the shelf arrangement by interchanging messages with processor element means in directly adjacent shelf units,
wherein the processor element means and the receiving means in the plurality of shelf units are able to be coupled to one another and to a central processing unit for a purpose of transmitting the data obtained using the receiver to the central processing unit.

30. A shelf unit comprising:
a shelf base;
at least one shelf vertical connection device, where the shelf base and the shelf vertical connection device can be releasably coupled to one another;
a receiving means which is set up to receive data from a data transmission unit fitted on an object which is to be arranged or is arranged in the shelf unit; and
a processing means which is set up such that it can determine a position of a processor element means of a shelf unit within the shelf arrangement by interchanging messages with processor element means in directly adjacent shelf units,
wherein the processor element means and the receiving means are coupled to one another and to a central processing unit for a purpose of transmitting the data obtained using the receiving means to the central processing unit.
